(19) United States
(12) Patent Application Publication
(10) Pub. No.: US 2026/0227023 A1
(43) Pub. Date: Aug. 6, 2026

(54) DEVICE AND METHOD FOR IMPROVING A VACUUM INSULATED COUPLING

(71) Applicant: MANN TEKNIK AB, MARIESTAD (SE)

(72) Inventors: Gerhard KOPPLIN, MARIESTAD (SE); Guanying LI, Töreboda (SE)

(73) Assignee: MANN TEKNIK AB, MARIESTAD (SE)

(21) Appl. No.: 19/150,369

(22) PCT Filed: May 31, 2024
(86) PCT No.: PCT/SE2024/050542

§ 371 Date: Jul. 23, 2025

(30) Foreign Application Priority Data
Jun. 2, 2023 (SE) 2350684-3

(51) Int. Cl. F16L 59/18; F16L 37/32; F17C 13/00

(52) U.S. Cl. CPC F16L 59/188; F16L 37/32; F17C 13/00; F17C 2203/0391; F17C 2205/037

(57) ABSTRACT

A coupling (1) for liquefied gas comprising a first part (1a) and a second part (1b) to be coupled to each other by insertion of the first part (1a) into the second part (1b), each part (1a, 1b) comprises an internal liquefied gas conduit (13) to be fluidly connected for transfer of liquefied gas through the coupling (1), the coupling (1) further comprises a warm seal (7) and a cold seal (8) characterized in the coupling (1) further comprises a warm gas inlet (10) arranged to receive a heated gas flow for heating the warm seal (7).

### TECHNICAL FIELD

The present invention relates generally to a device and method for improving a vacuum insulated coupling.

### BACKGROUND

In prior art different solutions for transferring liquified gases are well known. Couplings for liquefied gases, such as liquefied petroleum gas (LPG), liquefied natural gas (LNG), and liquefied hydrogen (LH2) are known in the art. Further, quick connectors are also known as Dry Disconnect Couplings and used in for example chemical and petrochemical applications, Aviation refueling, loading, and unloading of Liquefied Petroleum Gas (LPG) and also for cryogenic applications like fueling and bunkering of Liquefied Natural Gas (LNG) or Liquid hydrogen (LH2).

As known in the art liquified gases requires less volume for storage, are safer to store, and safer to transfer in a liquid state than in its corresponding gas form. However, the low boiling point of useful gases requires many liquified gases to be stored at low temperatures. For example, in atmospheric pressure the gas for LNG is condensed to liquid at temperatures below approximately −160° C., liquid hydrogen, LH2, at temperatures below approximately −250° C., and nitrogen for liquid nitrogen, LN2, approximately −195° C.

Liquified gases are used for different purposes but independent of the purpose efficiency and safety are important factors. To provide one out of many examples, liquified gases may be used as fuel and need to be transferred to a vehicle. Other examples are bunkering and transfer between vessels and storage. Although the transfer as such is well known in the art there are drawbacks relating to how couplings for such transfers are designed and function.

When transferring liquified gas, couplings are a critical and vulnerable component where thermal bridges and other problems exists in the prior art. One reason for this is that couplings for transfer of liquified gas typically are made of metal with relatively good thermal conductivity in the material.

Transferring liquified gases, such as LNG or LH2, through a coupling lowers the temperature of the coupling and especially in the area closest to the unit the coupling is connected to. The temperature of the outside parts of the coupling thus rapidly decreases during transfer of the liquified gas. The coupling is simultaneously subjected to the temperatures of the surrounding air, in general a common outdoor environment. The temperature outside of the coupling at transfer of liquified gas is significantly higher than the temperature of the liquefied gas. The low temperature of the coupling makes humidity in the air condensate onto the coupling that immediately freeze to ice due to the low temperature of the liquified gas that is transferred.

### SUMMARY OF INVENTION

For the purpose of this disclosure the word coupling is used to describe the complete coupling device comprising both a male and female part to be connected creating a fluid connection. In different embodiments components of the coupling might be arranged on either the male or female part depending on the design and selections made by the person skilled in the art. Further, in different embodiments components could be arranged for example on either a hose unit or a tank unit within the scope of the solution as described herein.

Liquified gas coupling that is covered with ice or moisture is not safe to use. Keeping such couplings dry provides a challenge given that liquified gas couplings often are operated in areas with an explosive atmosphere and thus subject to vast safety requirements, such as the ATEX directives. Keeping a coupling dry and safe to use is not a simple action of heating or drying the coupling quickly using high power creating vast amount of heat. High power and high temperatures are two unwanted and dangerous parameters in areas with explosive atmospheres.

Further, various couplings are known to mitigate the problem by reducing the thermal bridge in the coupling by insulation, such as vacuum insulation. Such couplings often also mitigate the thermal bridge in the coupling interface as will be described below. Examples are Johnston type couplings and other types of vacuum-insulated couplings. These couplings utilize a space formed between a cold and a warm seal to reduce the thermal bridge in the coupling interface. This requires the cold and warm seals to be spaced apart increasing the length of the coupling. Seals at low temperatures lose elastic properties and thus lose tightness, this behavior increase risk of leakage and is a clear example of problems related to transfer of liquified gas.

However, even if vacuum insulated couplings are used ice starts to build on the outside of the coupling, especially if the coupling is used for long periods of time. One reason for this is that the temperature in the vacuum-insulated coupling decreases between the cold and warm seals over time.

One way to mitigate the problem is to increase the length of the vacuum-insulated coupling and thus increase the space between the cold and warm seals. This has the drawback that the size of the coupling increases. In many application areas the space for the coupling is limited, for example in order to optimize the function of a vacuum insulated tank.

Thus an object is to reduce the length of vacuum-insulated couplings without reducing its ability to mitigate the thermal bridge.

Another object is to increase the time a coupling could continuously be used for transfer without ice building on the outside.

Yet another object is to increase safety of the coupling for the operator.

Thus, the solution relates to a coupling for liquefied gas comprising a first part and a second part to be coupled to each other by insertion of the first part into the second part. Each part comprises an internal liquefied gas conduit to be fluidly connected for transfer of liquefied gas through the coupling. The coupling further comprises a warm seal, a cold seal and a warm gas inlet arranged to receive a heated gas flow for heating the warm seal.

It is one advantage with the present solution that a heated gas flow entering the coupling at the warm gas inlet helps maintaining the temperature of the warm seal. It is another advantage that any unwanted leakage is reduced in concentration by the heated gas flow before being vented out of the coupling. It is yet another advantage that the length between the warm and cold seals can be reduced without compromising the function of the coupling.

It is another advantage that seals in low temperature conditions tend to perform worse in terms of tightness, endurance, and flexibility, especially under loads. In ambient temperatures they generally perform better, thus the solution as described herein creates a higher temperature condition for the warm seal/warm side seals.

This increases the safety of the coupling and reduce the length requirement of the coupling. Advantageously, the thermal conduction is balanced from liquified gas conduct and will not influence the function of transporting the liquified gas.

Yet another advantage is that the coupling and method as described herein allows for using compressed air instead of nitrogen (N2), this enhance the economic performance of the coupling over time given that compressed air as the heated gas flow is less expensive than nitrogen.

According to an embodiment the first part is a male part and the second part is a female part.

According to an embodiment the solution relates to a coupling for liquefied gas comprising a first male part and a second female part to be coupled to each other by insertion of the first part into the second part. Each part comprises an internal liquefied gas conduit to be fluidly connected for transfer of liquefied gas through the coupling. The coupling further comprises a warm seal, a cold seal and a warm gas inlet arranged to receive a heated gas flow for heating the warm seal.

According to an embodiment the warm seal and the cold seal are arranged to seal the interface between the first part and the second part forming a space between the warm seal and the cold seal. The warm seal is arranged to seal the space from the outside atmosphere and the cold seal is arranged to seal the liquefied gas conduit from the space.

According to an embodiment the coupling further comprise a leak detection seal arranged between the warm seal and the outside atmosphere forming a leak detection space between the warm seal and the leak detection seal.

According to an embodiment a sensor is arranged to detect any leakage passing the warm seal into the leak detection space.

According to an embodiment at least one additional seal is arranged between the warm gas channel and the warm seal.

According to an embodiment a leak detection seal is arranged to seal a leak detection space between the leak detection seal and the warm seal. The warm seal is arranged to seal the leak detection space from the space between the warm and cold seals. The leak detection seal is arranged to seal the second space from the outside atmosphere.

According to an embodiment the warm gas inlet is in fluid connection with the outside atmosphere through the interface between the first part and the second part. In different embodiments the warm gas inlet thus may be arranged either at a distal or proximal end of the interface between a male and female part depending on the overall design of the coupling.

According to an embodiment the outlet position is in the interface between the first and second coupling parts.

According to an embodiment the outlet position is a warm gas outlet.

According to an embodiment the outlet position is the opening to the outside atmosphere formed in the interface between the male and female coupling parts.

According to an embodiment the outlet position is arranged at the distal end of the interface between the male part and the female part.

According to an embodiment the warm gas channel is connected to the outlet position arranged at the open end of the interface between the first part and the second part. The open end of the interface is the connection point between the first part and second part wherein the interface meets the outside atmosphere.

According to an embodiment the warm gas inlet is fluidly connected to a warm gas channel delimited at one side of an intermediate part. The intermediate part is arranged between the warm gas channel and the warm seal.

According to an embodiment the intermediate part is heated by the heated gas flow.

It is one advantage that the intermediate part heats the warm seal indirectly, thus the sealing ability of the warm seal is not affected in any negative way.

According to an embodiment the intermediate part is arranged such that the intermediate part heats the warm seal.

According to an embodiment the female part further comprises an intermediate part to be heated by the warm gas.

According to an embodiment the male part further comprises an intermediate part to be heated by the warm gas.

According to an embodiment the coupling is a vacuum insulated coupling.

According to an embodiment the warm gas inlet is arranged at a proximal end of the coupling and the outlet position is arranged at a distal end of the coupling.

According to an embodiment the warm gas inlet is in fluid connection with the warm gas channel, the warm gas channel is arranged to heat the intermediate part. The warm gas channel is in fluid connection with the interface between the coupler and receptacle, i.e. the male and female parts.

According to an embodiment the coupler is the male part and the receptacle is the female part.

According to an embodiment the coupler is the female part and the receptacle is the male part.

According to an embodiment the coupling is a coupling for transfer of cryogenic liquefied gas.

According to an embodiment the warm seal is divided from the warm gas flow and only indirectly heated.

According to an embodiment the heated gas flow heats all or any one of the warm seal, a secondary seal, parts of the coupling, and the leak detection seal.

According to an embodiment the warm seal is directly heated by the heated gas flow.

According to an embodiment the intermediate part to be heated by the warm gas at one side is in contact with the warm gas channel and at the opposite side abuts the warm seal.

According to an embodiment any one of the temperature of the heated gas flow and the flow rate of the heated gas flow is regulated based on sensor data.

According to an embodiment the temperature of the coupling is monitored to ensure balance between the warm and cold seals.

It is one advantage with the present solution that the temperature at the warm seal can be controlled. If it is too warm it risks heating the coupling and the liquified gas flow, if it is too low the risk for ice building up increases.

According to an aspect the coupling comprising a female part to be coupled to a male part by insertion of the male part into the female part. Each part comprises an internal liquefied gas conduit to be fluidly connected for transfer of liquefied gas through the coupling. When the first and second parts are connected the coupling comprises a warm seal and a cold seal. The female part further comprise a warm gas inlet adapted to receive a heated gas and the warm gas inlet is connected to a warm gas channel heating part of the coupling such that the warm seal is indirectly heated.

According to an aspect in a coupling for liquefied gas comprising a first male part and a second female part to be coupled to each other by insertion of the first part into the second part, each part comprises an internal liquefied gas conduit to be fluidly connected for transfer of liquefied gas through the coupling. The coupling further comprises a warm seal and a cold seal. At a warm gas inlet a heated gas flow is supplied to the coupling.

According to an embodiment, the heated gas flow enters the coupling at the warm gas inlet, flows through the warm gas channel, and leaves the coupling in the interface between the male part and the female part.

According to an aspect of the present disclosure it is provided a coupling part for a coupling according to any aspect of the present disclosure, comprising an internal liquefied gas conduit to be fluidly connected for transfer of liquefied gas through the coupling, wherein with the first part and second parts interconnected the coupling comprises a warm seal and a cold seal, wherein in the coupling part further comprise a warm gas inlet adapted to receive a heated gas, and wherein the warm gas inlet is connected to a warm gas channel heating part of the coupling such that the warm seal is indirectly heated.

According to an aspect of the present disclosure it is provided a method in a coupling for liquefied gas comprising a first part and a second part to be coupled to each other by insertion of the first part into the second part, each part comprises an internal liquefied gas conduit to be fluidly connected for transfer of liquefied gas through the coupling, the coupling further comprises a warm seal and a cold seal wherein the coupling further comprises a warm gas inlet and method comprises the step of: supplying a heated gas flow to the warm gas inlet.

According to an embodiment the heated gas flow enters the coupling at the warm gas inlet, flows through the warm gas channel, and leaves the coupling in the interface between the first part and the second part.

According to an embodiment the coupling is a coupling according to any aspect of the present disclosure.

### BRIEF DESCRIPTION OF DRAWINGS

The invention is now described, by way of example, with reference to the accompanying drawings, in which:

FIG. 1 illustrates one embodiment of a coupling comprising a first male part and a second female part.

FIG. 2 illustrates one embodiment of a coupling.

FIG. 3 illustrates a cross section of one embodiment of part of a coupling.

### DESCRIPTION OF EMBODIMENTS

In the following, a detailed description of the different embodiments of the invention is disclosed under reference to the accompanying drawings. All examples herein should be seen as part of the general description and are therefore possible to combine in any way of general terms. Individual features of the various embodiments and aspects may be combined or exchanged unless such combination or exchange is clearly contradictory to the overall function of the device or method.

In this description, the term coupling will denote two halves of connecting units with internal valves, containing a female part in the form of a receptacle, nozzle, hose unit, or coupler, and a male part in the form of a receptacle, nozzle, hose unit, or coupler. The receptacle is mostly vacuum installed and could for example be arranged on a transport unit like tank truck, rail car or receiving vessel but could also be stand alone, while the coupler is mostly vacuum installed on the supply unit like flexible hose from a fueling station, loading arm from a storage tank, supply tanker, or bunker vessel, other applications are also possible within the scope of the disclosure.

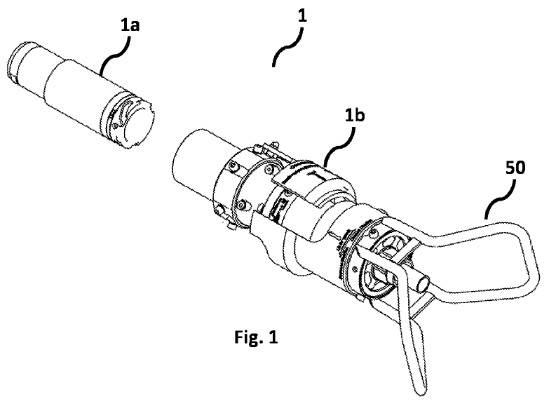

Turning now to FIG. 1 illustrating a coupling, generally designated 1, comprising a receptacle 1a and a coupler 1b to be coupled to each other by insertion of the male part 1a into the female part 1b. The interconnection is achieved by first inserting the receptacle 1a into the coupler 1b and then rotating the coupler 1b around a center axis thereof by turning handles 50 attached to the coupler 1b. Since the receptacle 1a generally is fixed against rotation by means of its attachment to the for example the receiving vessel, there will be a mutual rotation between the coupler 1b and the receptacle 1a. It shall be noted that the male part 1a and female part 1b in different embodiments could be built differently with for example the male or female part being either a coupler or a receptacle. Thus, the rotation, handle, and other parts of the coupling could in different embodiments be related to either the male or female part.

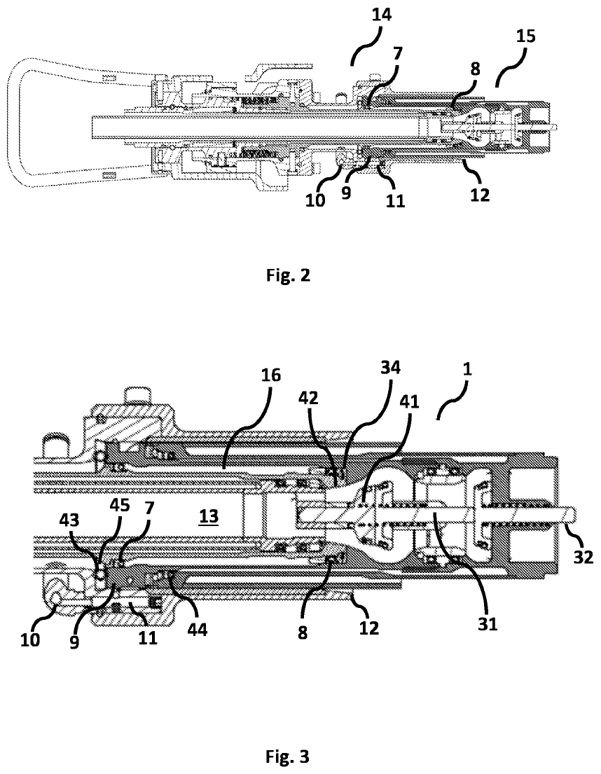

FIG. 2 illustrates a cross section of one embodiment of a connected coupling 1 wherein the parts 1a, 1b are connected forming a coupling 1. In the cross section as illustrated the warm seal 7 and cold seal 8 are visible. FIG. 2 further illustrates one embodiment of a proximal end 14 and distal end 15 of the coupling 1. The warm gas inlet 10 is shown as well as the warm gas channel 11 within the coupling 1. In the embodiment as shown in FIG. 2 the warm gas inlet 10 and the warm gas channel 11 are arranged on the coupler 1b, however in a different embodiment the warm gas inlet 10 could be arranged at the receptacle 1a instead depending of the coupling 1 design. The warm gas channel 11 could in one embodiment be formed between the receptacle 1a and coupler 1b, in another embodiment it could be arranged in the receptacle 1a.

FIG. 2 further illustrates one embodiment of the intermediate part 9 arranged for indirect heating of the warm seal 7. The intermediate part 9 is heated by the warm gas flowing into the warm gas inlet 10, such as compressed air or any other suitable gas or mixture, and heat is transferred to the warm seal 7 without affecting its ability to seal. FIG. 2 also illustrates how the warm gas is vented out via the interface between the receptacle 1a and coupler 1b, taking any moisture or other residue with it to the outside atmosphere. This rapidly increases the safety of the coupling 1 and decreases the required length between the warm seal 7 and cold seal 8.

FIG. 3 illustrates one embodiment of a connected coupling 1, wherein the distance between the warm 7 and cold 8 seals are clearly shown. As illustrated, the warm seal 7 is arranged to seal the space 16 from the outside atmosphere and the cold seal 8 is arranged to seal the liquefied gas conduit 13 from the space 16. FIG. 3 is a magnification of the illustration in FIG. 2 where the path for the heated gas flow is clearly visible. The heated gas flow enters the coupling at the warm gas inlet 10 and further flows into the warm gas channel 11 wherein the intermediate part 9 is heated by the flow. The warm gas channel 11 ends in the interface between the coupler 1b and the receptacle 1a and flows out to the outlet position 12 and into the surrounding atmosphere. It shall be noted that the outlet position 12 in different embodiments could be a separate outlet, a suitable opening, or any other suitable means to vent out the heated gas flow.

FIG. 3 further illustrates other parts of the coupling that shows how an embodiment of a coupling 1 could be arranged. For example, the coupler 1b comprise a valve 41 arranged to open by retraction of an outer section 42 upon contact with a contact surface 34 of the receptacle 1a. The valve 41 is further arranged to actuate a first valve 31 of the receptacle 1a. In the embodiment of FIG. 3 the receptacle 1a further comprise a second valve 32. It should further be noted that the receptacle 1a and coupler 1b although described herein as male and female parts in some embodiments comprise internal parts interacting such that for example part of the female part extends into the male part. It should further be noted that the positions of the warm 7 and cold 8 seals relates to their arrangement in relation to the liquified gas conduit 13 and outside atmosphere rather than their position in relation to other parts of the coupling 1 in some embodiments.

In FIG. 3 the warm seal 7 is arranged at the proximal end 14 of the coupler 1b providing an arrangement wherein the heated gas flow may flow from the warm gas inlet 10, through the coupling 1 and out at the outlet position 12 in a direction away from the operator and the handle. The warm seal 7 is arranged to seal the space 16 from the outside atmosphere. The interface between the receptacle and coupler is in the embodiment as illustrated in FIG. 3 the path between the outside atmosphere and the warm seal 7. This enables that any leakage at the warm seal 7 could effectively be vented by the heated gas flow.

FIG. 3 further illustrates one of the advantages with the present solution wherein the heated gas flow that enters the warm gas inlet 10 and heats the warm seal 7. Through maintaining a balance in the temperature of the warm seal 7 the distance between the warm seal 7 and the cold seal 8 could be decreased without compromising the insulating ability of the coupling 1. Thus, the length of the coupling 1 might be decreased enabling for less expensive production and couplings that are usable in application areas with limited available space.

FIG. 3 illustrates a leak detection space 45 formed between the warm seal 7 and a leak detection seal 43. In the leak detection space 45 a sensor could be arranged to detect leakage in the coupling interface. The sensor could provide sensor data that for example could control any one of the temperature or flow rate of the heated gas flow.

FIG. 3 further illustrates how the material of the coupling 1, and especially the intermediate part 9, is heated by the heated gas flow. Heating the coupling 1 and intermediate part 9 enables the entire coupling to maintain a more suitable temperature, thus reducing the risk for moisture, condensation, and ice. As shown, FIG. 3 also illustrates secondary seals and other parts of the coupling.

1-15. (canceled)

16. A coupling for liquefied gas comprising a first part and a second part to be coupled to each other by insertion of the first part into the second part, each part comprises an internal liquefied gas conduit to be fluidly connected for transfer of liquefied gas through the coupling, the coupling further comprises a warm seal and a cold seal wherein the coupling further comprises a warm gas inlet arranged to receive a heated gas flow for heating the warm seal.

17. The coupling according to claim 16, wherein the warm seal and the cold seal are arranged to seal the interface between the first part and the second part forming a space between the parts located between the warm seal and the cold seal, wherein the warm seal is arranged to seal the space from the outside atmosphere and the cold seal is arranged to seal the liquefied gas conduit from the space.

18. The coupling according to claim 16, wherein the coupling further comprise a leak detection seal arranged between the warm seal and the outside atmosphere forming a leak detection space between the warm seal and the leak detection seal.

19. The coupling according to claim 16, wherein the coupling comprises more than one warm seal.

20. The coupling according to claim 16, wherein the warm gas inlet is in fluid connection with the outside atmosphere through the interface between the first part and the second part.

21. The coupling according to claim 16, wherein the warm gas inlet is fluidly connected to a warm gas channel delimited at one side of an intermediate part arranged between the warm gas channel and the warm seal, wherein the intermediate part is heated by the heated gas flow.

22. The coupling according to claim 21, wherein the intermediate part is arranged such that the intermediate part heats the warm seal.

23. The coupling according to claim 16, wherein the warm gas channel further comprises an outlet position arranged at the open end of the interface between the first part and the second part.

24. The coupling according to claim 23, wherein the outlet position is the opening to the outside atmosphere formed in the interface between the first and second coupling parts.

25. The coupling according to claim 16, wherein the coupling is a vacuum insulated coupling.

26. The coupling according to claim 16, wherein the coupling is a coupling for transfer of cryogenic liquefied gas.

27. A coupling part for a coupling according to claim 16, comprising an internal liquefied gas conduit to be fluidly connected for transfer of liquefied gas through the coupling, wherein with the first part and second parts interconnected the coupling comprises a warm seal and a cold seal in the coupling part further comprise a warm gas inlet adapted to receive a heated gas, and wherein the warm gas inlet is connected to a warm gas channel heating part of the coupling such that the warm seal is indirectly heated.

28. A method in a coupling for liquefied gas comprising a first part and a second part to be coupled to each other by insertion of the first part into the second part, each part comprises an internal liquefied gas conduit to be fluidly connected for transfer of liquefied gas through the coupling, the coupling further comprises a warm seal and a cold seal in the coupling further comprise a warm gas inlet and method comprises the step of:
supplying a heated gas flow to the warm gas inlet.

29. The method according to claim 28, wherein the heated gas flow enters the coupling at the warm gas inlet, flows through the warm gas channel, and leaves the coupling in the interface between the first part and the second part.

30. The method according to claim 28 wherein the coupling is a coupling for liquefied gas comprising a first part and a second part to be coupled to each other by insertion of the first part into the second part, each part comprises an internal liquefied gas conduit to be fluidly connected for transfer of liquefied gas through the coupling, the coupling further comprises a warm seal and a cold seal wherein the coupling further comprises a warm gas inlet arranged to receive a heated gas flow for heating the warm seal.
